(19) United States
(12) Patent Application Publication
(10) Pub. No.: US 2016/0248675 A1
(43) Pub. Date: Aug. 25, 2016

(54) METHOD AND APPARATUS FOR QCN-LIKE CROSS-CHIP FUNCTION IN MULTI-STAGE ETHERNET SWITCHING

(71) Applicants: Ruiming ZHENG, San Diego, CA (US); Yisheng XUE, San Diego, CA (US); QUALCOMM INCORPORATED, San Diego, CA (US)

(72) Inventors: Ruiming Zheng, Beijing (CN); Yisheng Xue, San Diego, CA (US)

(21) Appl. No.: 15/026,571

(22) PCT Filed: Nov. 13, 2013
(86) PCT No.: PCT/CN2013/087031

§ 371 Date: Mar. 31, 2016

(51) Int. Cl. H04L 12/801; H04L 12/931

(52) U.S. Cl. CPC H04L 47/11; H04L 49/351; H04L 47/12

(57) ABSTRACT

A method and apparatus for reducing data congestion in Clos networks is disclosed. A congestion detector is provided at an output port of a first layer of the Clos network. A pause timer is provided at an input port of a second layer of the Clos network. The congestion detector generates a feedback message indicating a data congestion level of the output port, and the pause timer determines a pause duration based on the feedback message. For example, the pause duration may be proportional to the congestion level of the output port of the first layer. A pause signal generator may also be provided at the input port to generate a first pause signal based on the pause duration. The pause signal generator may further output the pause signal to a transmitting device to suspend a transmission of data for the pause duration.

### TECHNICAL FIELD

The present embodiments relate generally to Clos networks, and specifically to techniques for controlling data congestion in Clos networks.

### BACKGROUND OF RELATED ART

A Clos network is a multi-stage switching network that is typically used in data center networks (DCNs). Clos networks typically comprise three stages of switching elements: an ingress stage, a middle stage, and an egress stage. FIG. 1 shows an exemplary Clos network 100 that may be used in Ethernet switching applications. The Clos network 100 includes a number of input modules 110(1)-110(3), a number of central modules 120(1)-120(3), and a number of output modules 130(1)-130(3). Data entering one of the input modules 110(1)-110(3) may be routed to one of the output modules 130(1)-130(3) via any of the available central modules 120(1)-120(3). Ideally, Ethernet switching should provide congestion notifications to enhance transport reliability without penalizing the performance of transport protocols.

Quantized Congestion Notification (QCN) is an Ethernet-layer congestion control mechanism that has been adopted by the IEEE 802.1Qau standard. A typical QCN mechanism includes a congestion point (CP) and a reaction point (RP). The CP corresponds with the primary point of data congestion in the network (e.g., switches) and the RP corresponds with the source of the data traffic (e.g., network interface cards). At the CP, a switch buffer samples incoming data packets and feeds back the congestion level (e.g., via a congestion feedback message) to the source of the sampled packets (e.g., to a corresponding RP). At the RP, a rate limiter associated with a data source may decrease its transmission rate based on the congestion feedback message from the CP. The RP may then gradually increase its transmission rate to recover the lost bandwidth and probe for additional available bandwidth.

Since RPs are typically implemented at the virtual output queues or mapping queues of a data source, QCN has been impractical to implement in a Clos network architecture due to the large number of virtual output queues in each input module 110. For example, a typical Clos network with 8 output modules, including 24 output ports per output module, would result in each input module having 1536 virtual output queues, which is not practical.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A device and method of operation are disclosed that may aid in reducing data congestion in Clos networks. A congestion detector is provided at an output port of a first layer of the Clos network and generates a feedback message indicating a congestion level of the output port. A pause timer is provided at an input port of a second layer of the Clos network to receive the feedback message from the congestion detector and to determine a pause duration based on the feedback message. For example, the pause duration may be proportional to the congestion level of the output port of the first layer.

For some embodiments, a pause signal generator may also be provided at the input port of the second layer of the Clos network to generate a first pause signal based on the pause duration. For example, the pause signal generator may output the first pause signal to a transmitting device to suspend a transmission of data from the transmitting device to the input port of the second layer for the pause duration.

For some embodiments, a pause output logic may be coupled to the pause signal generator to generate a second pause signal based on a logical combination of the first pause signal and a third pause signal. For example, the third pause signal may be a function of an Ethernet flow control protocol. The pause output logic may output the second pause signal to a transmitting device if at least one of the first pause signal or the third pause signal is asserted. Furthermore, the pause output logic may suspend output of the second pause signal upon detecting that one of the first pause signal or the third pause signal is de-asserted.

For some embodiments, the pause output logic may resume output of the second pause signal only when the de-asserted pause signal becomes asserted again. For other embodiments, the pause output logic may resume output of the second pause signal only when both the first and third pause signals are asserted.

Placing pause timers and/or pause signal generators at the input ports, and congestion detectors at the output ports, of a Clos network allows cross-chip congestion control functionality (similar to a Quantized Congestion Notification mechanism) to be implemented in the Clos network with reduced hardware costs (e.g., compared to conventional techniques for which reactions points are placed at the virtual output queues). Furthermore, selective usage of the pause signal enables a pause signal generator to control the flow of data traffic (i.e., to a corresponding output port) from the input port of the Clos network, without interfering with pause commands generated via existing Ethernet flow control protocols.

### BRIEF DESCRIPTION OF THE DRAWINGS

The present embodiments are illustrated by way of example and are not intended to be limited by the figures of the accompanying drawings, where:

FIG. 1 shows an exemplary Clos network that may be used in Ethernet switching applications;

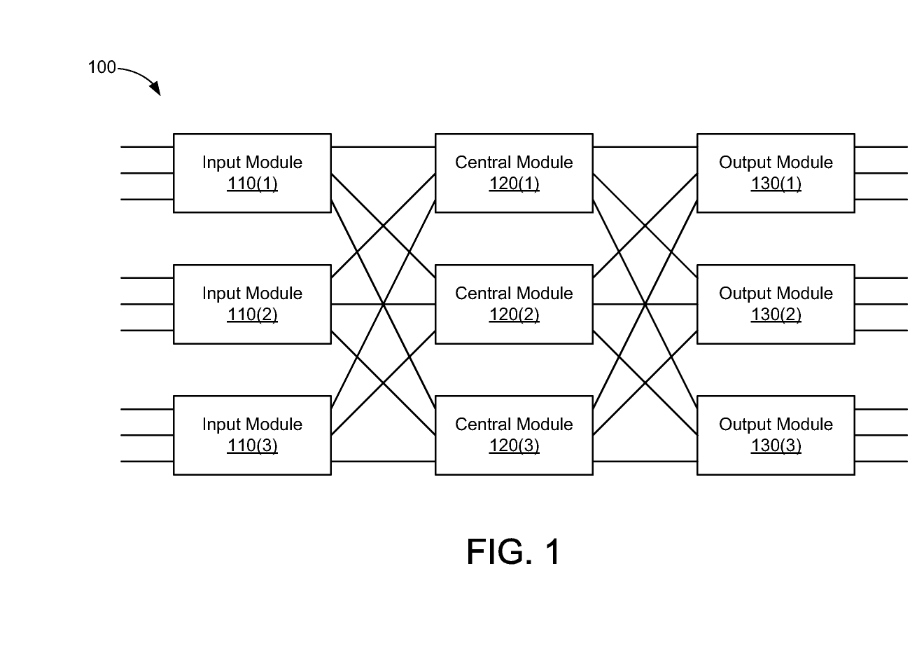

FIG. 2 shows a block diagram of a Clos network with QCN-like congestion control in accordance with some embodiments;

FIG. 3 shows a block diagram of a pause controller in accordance with some embodiments;

FIG. 4 shows a block diagram of a pause controller that may generate a hybrid pause signal in accordance with some embodiments;

FIG. 5 shows an exemplary timing diagram depicting the output of a hybrid pause signal in accordance with some embodiments;

FIG. 6 shows an exemplary timing diagram depicting the output of a hybrid pause signal in accordance with other embodiments;

FIG. 7 is an illustrative flow chart depicting a QCN-like congestion control operation in accordance with some embodiments; and

FIG. 8 shows a block diagram of a pause controller in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

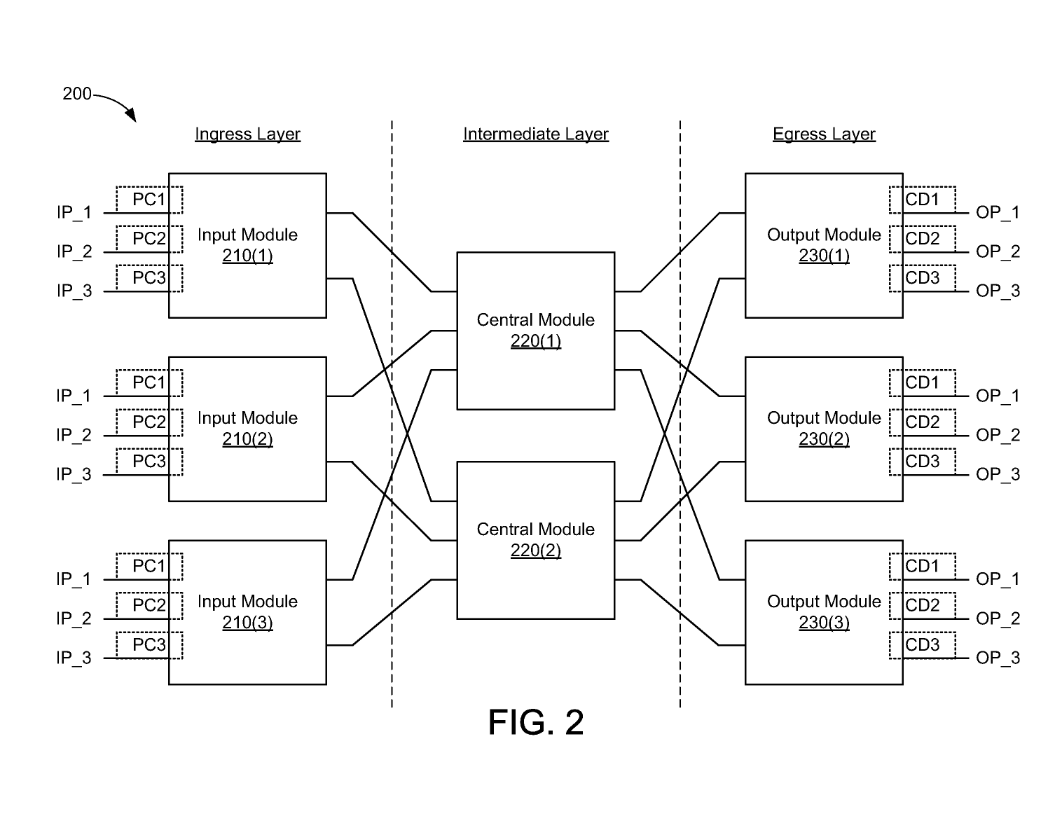

FIG. 2 shows a block diagram of a Clos network 200 with QCN-like congestion control in accordance with some embodiments. The Clos network 200 includes a number of input modules 210(1)-210(3) provided at an ingress layer of the Clos network 200, a set of central modules 220(1)-220(2) provided at an intermediate layer of the Clos network 200, and a number of output modules 230(1)-230(3) provided at an egress layer of the Clos network 200. For some embodiments, the Clos network 200 represents a fabric of interconnected switching elements, wherein each of the modules 210(1)-210(3), 220(1)-220(2), and 230(1)-230(3) corresponds to an individual switch (e.g., chip). Each of the input modules 210(1)-210(3) includes a number of input ports IP_1-IP_3. Each of the output modules 230(1)-230(3) includes a number of output ports OP_1 -OP_3. Data entering one of the input ports IP_1 -IP_3 of an input module 210(1), 210(2), or 210(3) may be routed, via the central modules 220(1) and/or 220(2), to an output port (OP_1, OP_2, or OP_3) of any one of the output modules 230(1)-230(3).

Congestion detectors CD1-CD3 are provided at respective output ports OP_1-OP_3 of each of the output modules 230(1)-230(3). Each congestion detector may output one or more congestion feedback messages to a corresponding pause controller based on the activity of a corresponding switch buffer. For some embodiments, a congestion detector may generate feedback messages in a manner similar to that of a congestion point (CP) of the Quantized Congestion Notification (QCN) protocol, for example, as described by the IEEE 802.1Qau standard. For example, with reference to output module 230(1), the congestion detector CD1 may sample each data packet entering a switch buffer (not shown, for simplicity) associated with the output port OP_1 and output a congestion feedback message to the pause controller from which that data packet originated. The congestion feedback message may indicate the congestion level at a corresponding output port, for example, based on the rate of data entering and/or exiting the corresponding switch buffer. The congestion level may also be based on the fullness of (or amount of data stored in) the switch buffer.

For some embodiments, the pause controllers PC1-PC3 are provided at respective input ports IP_1 -IP_3 of the input modules 210(1)-210(3). Upon receiving a congestion feedback message, a pause controller may control or throttle a transmission of data to the corresponding output port based on the congestion level indicated by the feedback message. For example, assuming data entering the input port IP_1 of input module 210(1) is routed to the output port OP_1 of output module 230(1), the congestion detector CD1 of output module 230(1) may transmit congestion feedback messages to the pause controller PC1 of input module 210(1). The pause controller PC1 may then adjust the flow of data directed to the output port OP_1 based on the congestion levels indicated in the feedback messages.

For some embodiments, a pause controller may control the transmission of data to a particular output port of an output module by selectively outputting a pause signal to a transmitting (TX) device from which the data originated. The pause signal may cause the TX device to (temporarily) stop transmitting any further data to the input port associated with that pause controller. This, in turn, may suspend the data traffic forwarded from the input port to the intended output port of an output module 230. For some embodiments, the pause signal output by the pause controller may be a function of existing Ethernet flow control frameworks. Further, for some embodiments, a pause controller may output the pause signal to a corresponding TX device based on a locally-generated pause signal and a pause signal generated via an existing Ethernet flow control mechanism.

It should be noted that, by adjusting the flow of data in response to a feedback message, a pause controller performs a function similar to that of a reaction point (RP) of the QCN protocol. Moreover, by placing pause controllers at the input ports of the input modules 210(1)-210(3), and congestion detectors at the output ports of the output modules 230(1)-230(3), QCN-like cross-chip congestion control functionality may be achieved in a Clos network with reduced hardware costs (e.g., compared to conventional means, wherein RPs would be located at the output ports or virtual output queues of the input modules 210(1)-210(3)). Furthermore, by utilizing pause signals that are already part of an existing Ethernet flow control framework, pause controllers may be able to control the flow of data from a TX device with little or no modifications to the TX device itself.

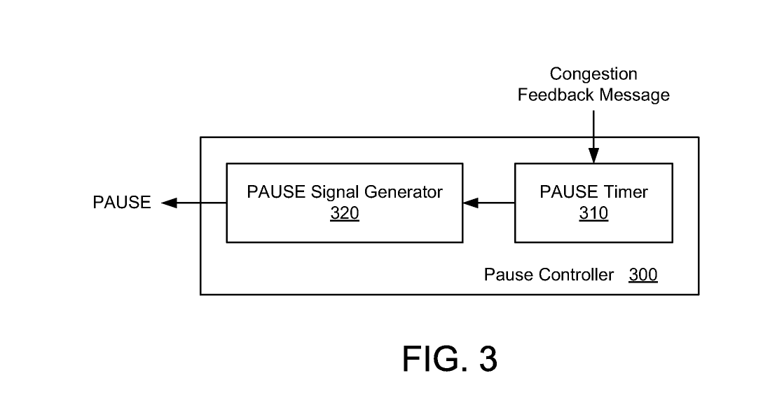

FIG. 3 shows a block diagram of a pause controller 300 in accordance with some embodiments. The pause controller 300 includes a PAUSE timer 310 and a PAUSE signal generator 320. The PAUSE timer 310 receives a congestion feedback message from a congestion detector and determines a pause duration based on the received feedback message. The pause duration may correspond to a duration of time for which data transmissions to the output port (from which the feedback message originated) are to be suspended, in order to reduce congestion at that output port. Thus, for some embodiments, the pause duration may be proportional to the congestion level at the output port associated with the congestion detector (i.e., as indicated in the congestion feedback message). For example, the PAUSE timer 310 may associate a longer pause duration with higher congestion levels, and a shorter pause duration with lower congestion levels.

For some embodiments, the pause duration may be calculated using the following equation:

$$pause duration = 2 \cdot \frac{Fb}{Gd} \cdot \frac{100 \cdot 1500 B}{LineSpeed} \qquad ( 1 )$$

where Fb is the feedback value of the received congestion feedback message, Gd is a global parameter applicable to the QCN standard, and LineSpeed is the communication speed of the line connected to the switch.

The PAUSE signal generator 320 selectively outputs a pause signal (PAUSE) based, in part, on the pause duration determined by the PAUSE timer 310. For example, the length of the pause signal (e.g., the duration for which PAUSE is asserted) may be directly proportional (or equal) to the pause duration in order to suspend the transmission of data by a corresponding TX device for such duration. For some embodiments, the PAUSE signal generator 320 may output the pause signal only if the line connected to the input port associated with the pause controller 300 is active. For example, the line connected to the input port may be paused and/or placed in an idle state by other Ethernet protocols and/or flow control mechanisms. Thus, the PAUSE signal generator 320 may first detect whether the line is already paused to avoid issuing a redundant pause command. If the line connected to the input port is active, the PAUSE signal generator 320 may output a pause signal to suspend the transmission of data by a corresponding TX device for the length of the pause duration.

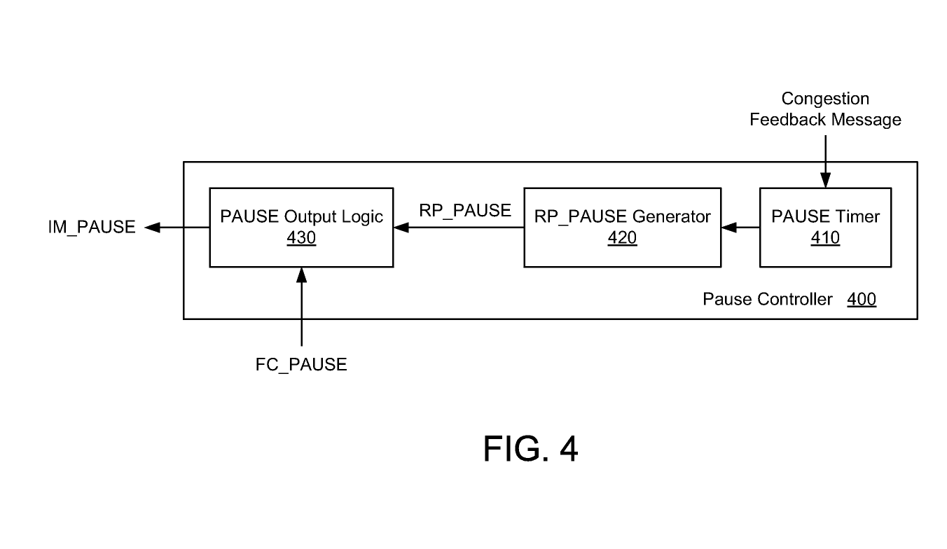

FIG. 4 shows a block diagram of a pause controller 400 that may generate a hybrid pause signal in accordance with some embodiments. The pause controller 400 includes a PAUSE timer 410, an RP_PAUSE generator 420, and a PAUSE output logic 430. The PAUSE timer 410 receives a congestion feedback message from a congestion detector and determines a pause duration based on the received feedback message. As described above with respect to FIG. 3, the pause duration may be proportional to the congestion level at the output port associated with the congestion detector. For some embodiments, the pause duration may be calculated using Equation 1. The RP_PAUSE generator 420 generates a local pause signal (RP_PAUSE) based on the pause duration determined by the PAUSE timer 410. For example, the RP_PAUSE generator 420 may assert RP_PAUSE for a duration that is directly proportional (or equal) to the pause duration.

The PAUSE output logic 430 selectively outputs a pause signal (IM_PAUSE) based on the local pause signal from the RP_PAUSE generator 420 and a pause signal (FC_PAUSE) generated via a network flow control mechanism. For some embodiments, FC_PAUSE may correspond to a pause signal that is generated as part of an existing Ethernet flow control framework. For example, the network pause signal (i.e., FC_PAUSE) may be asserted by other components of the input module to which the pause controller 400 belongs. Accordingly, the PAUSE output logic 430 may receive both the local pause signal and the network pause signal, and generate IM_PAUSE based on a (logical) combination of RP_PAUSE and FC_PAUSE. More specifically, IM_PAUSE may represent the final pause signal output by the pause controller 400 which may cause a corresponding TX device to stop transmitting data on the associated line.

For some embodiments, the PAUSE output logic 430 may initially output the pause signal only if the line connected to the input port associated with the pause controller 400 is active. For example, as described above with respect to FIG. 3, the PAUSE output logic 430 may first detect whether the line is already paused (e.g., by other Ethernet protocols and/or flow control mechanisms) to avoid issuing a redundant pause command. If the line connected to the input port is active, and at least one of the pause signals (RP_PAUSE and/or FC_PAUSE) is asserted, the PAUSE output logic 430 may output IM_PAUSE to suspend the transmission of data by a corresponding TX device.

For some embodiments, the PAUSE output logic 430 may suspend output of IM_PAUSE when one of the pause signals (RP_PAUSE or FC_PAUSE) becomes de-asserted. For example, the PAUSE output logic 430 may cease outputting IM_PAUSE in response to detecting a “pause off” trigger from a first source (e.g., corresponding to the de-assertion of one of the pause signals). Typically, a “pause off” trigger is associated with an immediate need and/or desire to resume the flow of data to a particular output port (e.g., as opposed to a pause signal simply idling in a de-asserted state). Thus, the PAUSE output logic 430 may suspend IM_PAUSE, while ignoring the status of any other pause signals, until it at least detects a subsequent “pause” or “pause on” trigger from the first source (e.g., corresponding to the de-asserted pause signal being asserted once again).

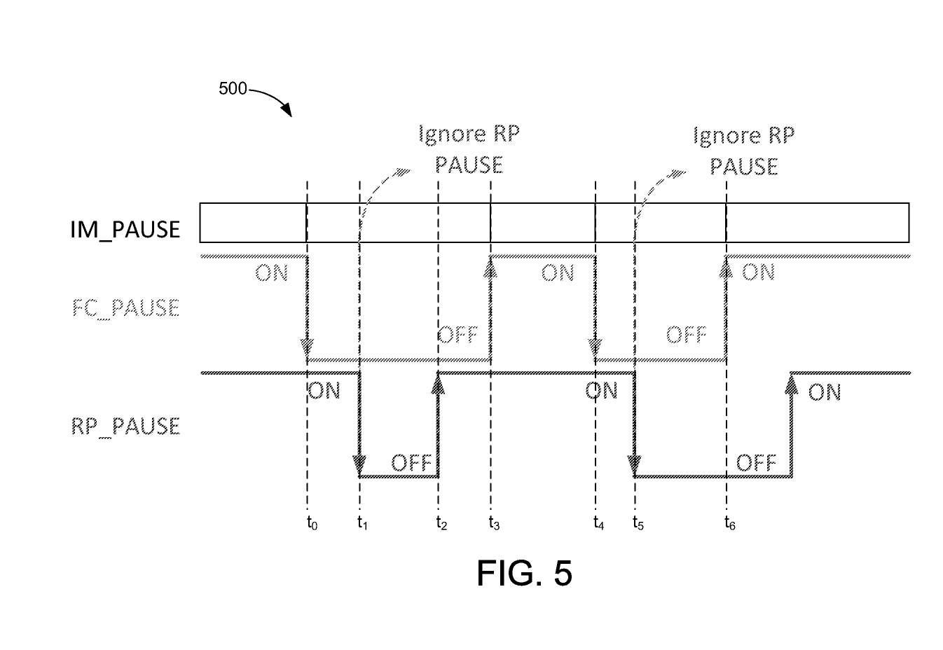

For some embodiments, the PAUSE output logic 430 may resume outputting IM_PAUSE once the de-asserted pause signal is asserted again, regardless of the current state of the other pause signal(s). For example, as shown in the timing diagram 500 of FIG. 5, the PAUSE output logic 430 suspends IM_PAUSE upon detecting a FC_PAUSE “OFF” trigger (at time t₀). The PAUSE output logic 430 then ignores the RP_PAUSE “OFF” trigger (at time t₁) as well as the subsequent RP_PAUSE “ON” trigger (at time t₂) since FC_PAUSE is still de-asserted. The PAUSE output logic 430 then resumes output of IM_PAUSE upon detecting the FC_PAUSE “ON” trigger (at time t₃). The PAUSE output logic 430 ceases output of IM_PAUSE once again in response to the next FC_PAUSE “OFF” trigger (at time t₄) and remains unaffected by the RP_PAUSE “OFF” trigger (at time t₅) while FC_PAUSE remains de-asserted. However, output of IM_PAUSE may be resumed in response to the FC_PAUSE “ON” trigger (at time t₆), even though RP_PAUSE remains de-asserted.

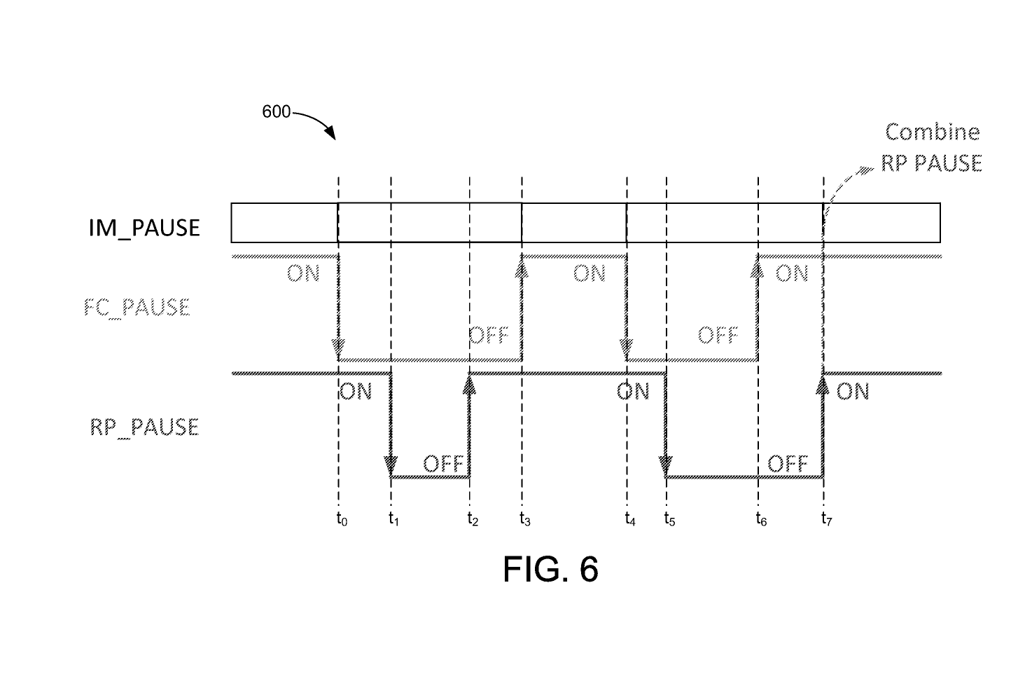

For other embodiments, the PAUSE output logic 430 may resume outputting IM_PAUSE only when all of the pause signals are asserted, concurrently. For example, as shown in the timing diagram 600 of FIG. 6, the PAUSE output logic 430 suspends IM_PAUSE upon detecting a FC_PAUSE “OFF” trigger (at time t₀). The PAUSE output logic 430 then ignores the RP_PAUSE “OFF” trigger (at time t₁) as well as the subsequent RP_PAUSE “ON” trigger (at time t₂) since FC_PAUSE is still de-asserted. The PAUSE output logic 430 then resumes output of IM_PAUSE upon detecting the FC_PAUSE “ON” trigger (at time t₃) since RP_PAUSE is also asserted at this time. The PAUSE output logic 430 ceases output of IM_PAUSE once again in response to the next FC_PAUSE “OFF” trigger (at time t₄) and remains unaffected by the RP_PAUSE “OFF” trigger (at time t₅) while FC_PAUSE remains de-asserted. However, the PAUSE output logic 430 also ignores the subsequent FC_PAUSE “ON” trigger (at time t₆) since RP_PAUSE remains de-asserted at this time. Finally, the PAUSE output logic 430 resumes output of IM_PAUSE in response to the RP_PAUSE “ON” trigger (at time t₇), since both FC_PAUSE and RP_PAUSE are asserted at this point.

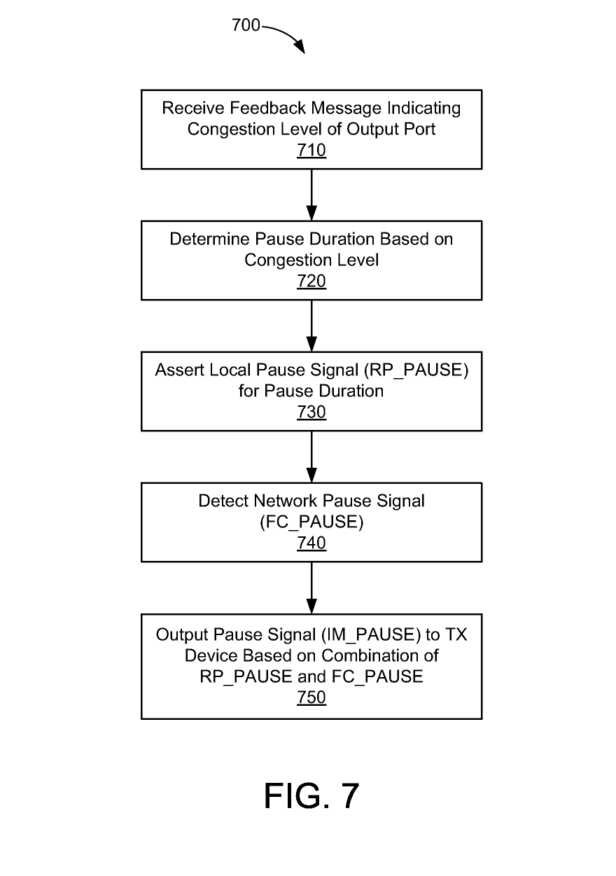

FIG. 7 is an illustrative flow chart depicting a QCN-like congestion control operation 700 in accordance with some embodiments. With reference, for example, to FIG. 4, the pause controller 400 first receives a feedback message indicating a congestion level of an output port in a Clos network (710). For some embodiments, the feedback message may be generated by a congestion detector provided at a particular output port of the output module (e.g., as described above with respect to FIG. 2). The congestion detector may determine the congestion level, for example, based on the rate of data entering and/or exiting a corresponding switch buffer associated with that output port.

The pause controller 400 determines a pause duration based on the congestion level indicated in the feedback message (720). The pause duration may correspond to a duration of time for which data transmissions to the output port (from which the feedback message originated) are to be suspended. For some embodiments, the pause duration may be proportional to the congestion level at that output port (e.g., as indicated by the received feedback message). For example, the PAUSE timer 410 may calculate the pause duration based on Equation 1 (e.g., as described above with respect to FIG. 3).

A local pause signal (RP_PAUSE) is then asserted for the pause duration (730). For example, the RP_PAUSE generator 420 may assert RP_PAUSE for a duration that is directly proportional (or equal) to the pause duration calculated by the PAUSE timer 410. As described above, with respect to FIGS. 4-6, the local pause signal may be used, in part, to suspend a transmission of data by a corresponding TX device (e.g., for the length of the pause duration).

The pause controller 400 may further detect network pause signal (FC_PAUSE) generated via a network flow control mechanism (740). As described above, with respect to FIG. 4, FC_PAUSE may be asserted by other components of the input module to which the pause controller 400 belongs. For some embodiments, the network pause signal may correspond to a pause signal that is generated as part of an existing Ethernet flow control framework.

Finally, the pause controller 400 outputs a pause signal (IM_PAUSE) to the TX device based on a logical combination of the local pause signal and the network pause signal (750). For example, the PAUSE output logic 430 may receive both RP_PAUSE and FC_PAUSE, and generate IM_PAUSE based on a logical combination of the two signals. For some embodiments, the PAUSE output logic 430 may output IM_PAUSE only if the line connected to the input port associated with the pause controller 400 is active. The pause signal may cause the TX device to stop transmitting data on the associated line for a specified duration (e.g., based on the duration of RP_PAUSE and/or FC_PAUSE). The PAUSE output logic 430 may initially output IM_PAUSE if at least one of the pause signals (RP_PAUSE and/or FC_PAUSE) is asserted. For some embodiments, the PAUSE output logic 430 may subsequently suspend output of IM_PAUSE upon detecting a “pause off” trigger from a first source (e.g., as described above with respect to FIG. 4).

While IM_PAUSE is suspended, the PAUSE output logic 430 may ignore the status of any other pause signals until it at least detects a subsequent “pause” or “pause on” trigger from the first source. For some embodiments, the PAUSE output logic 430 may resume outputting IM_PAUSE (e.g., after a suspension) once the de-asserted pause signal is asserted again, regardless of the current state of the other pause signal (e.g., as described above with respect to FIG. 5). For other embodiments, the PAUSE output logic 430 may resume outputting IM_PAUSE only when all of the pause signals are asserted, concurrently (e.g., as described above with respect to FIG. 6).

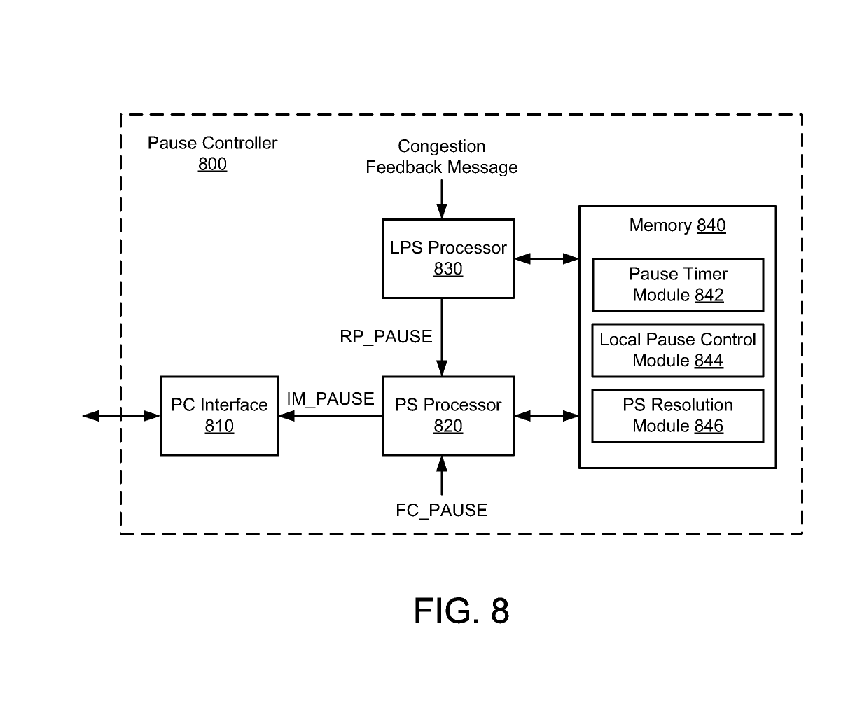

FIG. 8 is a block diagram of a pause controller 800 in accordance with some embodiments. The pause controller 800 may form at least a portion of the switching fabric for a Clos network. The pause controller 800 includes pause controller (PC) interface 810, a pause signal (PS) processor 820, a local pause signal (LPS) processor 830, and memory 840. The PC interface 810 may be used for communicating data to and/or from the pause controller 800. For example, the PC interface 810 may output pause signals (IM_PAUSE) generated by the PS processor 820 to a TX device. For some embodiments, the pause controller 800 may perform QCN-like congestion control operations based on congestion feedback messages received from a congestion detector provided at an output module of the Clos network (e.g., in addition to standard switching functions).

Memory 840 may include a non-transitory computer-readable storage medium (e.g., one or more nonvolatile memory elements, such as EPROM, EEPROM, Flash memory, a hard drive, etc.) that can store the following software modules:
a pause timer module 842 to determine a pause duration based on the congestion feedback message;
a local pause control module 844 to generate and/or assert a local pause signal for the determined pause duration; and
a PS resolution module 846 to generate a pause signal based on a logical combination of the local pause signal and a network pause signal.
   Each software module may include instructions that, when executed by the processors 820 and/or 830, may cause the pause controller 800 to perform the corresponding function. Thus, the non-transitory computer-readable storage medium of memory 840 may include instructions for performing all or a portion of the operations described above with respect to FIG. 7.

The processors 820 and 830, which are coupled between the PC interface 810 and the memory 840, may be any suitable processors capable of executing scripts of instructions of one or more software programs stored in the pause controller 800 (e.g., within memory 840). For example, the LPS processor 830 may execute the pause timer module 842 and the local pause control module 844, while the PS processor 820 may execute the PS resolution module 846.

The pause timer module 842 may be executed by the LPS processor 830 to determine a pause duration based on the congestion feedback message. The feedback message may be generated by a congestion detector, located at a particular output port of the Clos network, and may indicate the congestion level at that output port. The pause duration may correspond to a duration of time for which data transmissions to such output port are to be suspended. For some embodiments, the pause duration may be proportional to the congestion level at the output port. For example, the LPS processor 830, in executing the pause timer module 842 may calculate the pause duration based on Equation 1 (e.g., as described above with respect to FIG. 3).

The local pause control module 844 may be executed by the LPS processor 830 to generate and/or assert a local pause signal (RP_PAUSE) for the determined pause duration. For example, the LPS processor 830, in executing the local pause control module 844, may assert RP_PAUSE for a duration that is directly proportional (or equal) to the pause duration calculated by the pause timer module 842. As described above, with respect to FIGS. 4-6, the local pause signal may be used, in part, to suspend a transmission of data by a corresponding TX device (e.g., for the length of the pause duration).

The PS resolution module 846 may be executed by the PS processor 820 to generate a pause signal based on a logical combination of the local pause signal and a network pause signal (FC_PAUSE). As described above, with respect to FIG. 4, FC_PAUSE may be asserted by other components of the input module to which the pause controller 800 belongs (not shown for simplicity). For some embodiments, the network pause signal may correspond to a pause signal that is generated as part of an existing Ethernet flow control framework. For some embodiments, the PS processor 820, in executing the PS resolution module 846, may output IM_PAUSE only if the line connected to the PC interface 810 is active. The pause signal may cause the TX device to stop transmitting data on the associated line for a specified duration (e.g., based on the duration of RP_PAUSE and/or FC_PAUSE).

The PS resolution module 846, as executed by the PS processor 820, may initially output IM_PAUSE if at least one of the pause signals (RP_PAUSE and/or FC_PAUSE) is asserted. The PS processor 820 may subsequently suspend output of IM_PAUSE upon detecting a “pause off” trigger from a first source (e.g., as described above with respect to FIG. 4). While IM_PAUSE is suspended, the PS processor 820 may ignore the status of any other pause signals until it at least detects a subsequent “pause” or “pause on” trigger from the first source. For some embodiments, the PS processor 820, in executing the PS resolution module 846, may resume outputting IM_PAUSE (e.g., after a suspension) once the de-asserted pause signal is asserted again, regardless of the current state of the other pause signal (e.g., as described above with respect to FIG. 5). For other embodiments, the PS processor 820 may resume outputting IM_PAUSE only when all of the pause signals are asserted, concurrently (e.g., as described above with respect to FIG. 6).

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, the method steps depicted in the flow chart of FIG. 7 may be performed in other suitable orders, multiple steps may be combined into a single step, and/or some steps may be omitted. In another example, while modules in FIG. 8 are depicted as software in memory 840, any of the modules may be implemented in hardware, software, firmware, or a combination of the foregoing.

What is claimed is:

1. A Clos network comprising:
a congestion detector, provided at an output port of a first layer of the Clos network, to generate a feedback message indicating a data congestion level of the output port; and
a pause timer, provided at an input port of a second layer of the Clos network, to receive the feedback message from the congestion detector and to determine a pause duration based on the feedback message, wherein the second layer precedes the first layer in the Clos network.

2. The Clos network of claim 1, wherein the pause duration is proportional to the data congestion level of the output port of the first layer.

3. The Clos network of claim 1, further comprising:
a pause signal generator, provided at the input port of the second layer of the Clos network, to generate a first pause signal based on the pause duration.

4. The Clos network of claim 3, wherein the pause signal generator is to output the first pause signal to a transmitting device to suspend a transmission of data from the transmitting device to the input port of the second layer for the pause duration.

5. The Clos network of claim 3, further comprising:
a pause output logic coupled to the pause signal generator to generate a second pause signal based on a logical combination of the first pause signal and a third pause signal, wherein the third pause signal is a function of an Ethernet flow control protocol.

6. The Clos network of claim 5, wherein the pause output logic is to:
output the second pause signal to a transmitting device if at least one of the first pause signal or the third pause signal is asserted; and
suspend output of the second pause signal upon detecting that one of the first pause signal or the third pause signal is de-asserted.

7. The Clos network of claim 6, wherein the pause output logic is to resume output of the second pause signal only when the de-asserted pause signal is asserted again.

8. The Clos network of claim 6, wherein the pause output logic is to resume output of the second pause signal only when both the first pause signal and the third pause signals are asserted.

9. A method of congestion control in a Clos network, the method comprising:
receiving a feedback message indicating a data congestion level of an output port of a first layer of the Clos network; and
determining a pause duration, at an input port of a second layer of the Clos network, based on the feedback message, wherein the second layer precedes the first layer in the Clos network.

10. The method of claim 9, wherein the pause duration is proportional to the data congestion level of the output port of the first layer.

11. The method of claim 9, further comprising:
generating a first pause signal based on the pause duration.

12. The method of claim 11, further comprising:
outputting the first pause signal to a transmitting device to suspend a transmission of data from the transmitting device to the input port of the second layer for the pause duration.

13. The method of claim 11, further comprising:
generating a second pause signal based on a logical combination of the first pause signal and a third pause signal, wherein the third pause signal is a function of an Ethernet flow control protocol.

14. The method of claim 13, further comprising:
outputting the second pause signal to a transmitting device if at least one of the first pause signal or the third pause signal is asserted; and
suspending output of the second pause signal upon detecting that one of the first pause signal or the third pause signal is de-asserted.

15. The method of claim 14, wherein suspending output of the second pause signal further comprises:
resuming output of the second pause signal only when the de-asserted pause signal is asserted again.

16. The method of claim 14, wherein suspending output of the second pause signal further comprises:
resuming output of the second pause signal only when both the first pause signal and the third pause signals are asserted.

17. A computer-readable storage medium containing program instructions that, when executed by a processor provided within a pause controller at an input port of a first layer of a Clos network, causes the pause controller to:
receive a feedback message indicating a data congestion level of an output port of a second layer of the Clos network, wherein the first layer precedes the second layer in the Clos network; and
determine a pause duration based on the feedback message, wherein the pause duration is proportional to the data congestion level of the output port of the second layer.

18. The computer-readable storage medium of claim 17, further comprising program instructions that cause the pause controller to:
generate a first pause signal based on the pause duration.

19. The computer-readable storage medium of claim 18, further comprising program instructions that cause the pause controller to:
generate a second pause signal based on a logical combination of the first pause signal and a third pause signal, wherein the third pause signal is a function of an Ethernet flow control protocol.

20. The computer-readable storage medium of claim 19, wherein execution of the program instructions to generate the second pause signal further causes the pause controller to:
output the second pause signal to a transmitting device if at least one of the first pause signal or the third pause signal is asserted; and
suspend output of the second pause signal upon detecting that one of the first pause signal or the third pause signal is de-asserted.

21. The computer-readable storage medium of claim 20, wherein execution of the program instructions to generate the second pause signal further causes the pause controller to:
resume output of the second pause signal only when the de-asserted pause signal is asserted again.

22. The computer-readable storage medium of claim 20, wherein execution of the program instructions to generate the second pause signal further causes the pause controller to:
resume output of the second pause signal only when both the first pause signal and the third pause signals are asserted.

23. A pause controller provided at an input port of a first layer of a Clos network, the pause controller comprising:
means for receiving a feedback message indicating a data congestion level of an output port of a second layer of the Clos network, wherein the first layer precedes the second layer in the Clos network; and
means for determining a pause duration based on the feedback message.

24. The pause controller of claim 23, wherein the pause duration is proportional to the data congestion level of the output port of the second layer.

25. The pause controller of claim 23, further comprising:
means for generating a first pause signal based on the pause duration.

26. The pause controller of claim 25, wherein the means for generating the first pause signal is to:
output the first pause signal to a transmitting device to suspend a transmission of data from the transmitting device to the input port of the first layer for the pause duration.

27. The pause controller of claim 25, further comprising:
means for generating a second pause signal based on a logical combination of the first pause signal and a third pause signal, wherein the third pause signal is a function of an Ethernet flow control protocol.

28. The pause controller of claim 27, wherein the means for generating the second pause signal is to:
output the second pause signal to a transmitting device if at least one of the first pause signal or the third pause signal is asserted; and
suspend output of the second pause signal upon detecting that one of the first pause signal or the third pause signal is de-asserted.

29. The pause controller of claim 28, wherein the means for generating the second pause signal is to further:
resume output of the second pause signal only when the de-asserted pause signal is asserted again.

30. The pause controller of claim 28, wherein the means for generating the second pause signal is to further:
resume output of the second pause signal only when both the first pause signal and the third pause signals are asserted.
